(19) United States
(12) Patent Application Publication
(10) Pub. No.: US 2008/0062616 A1
(43) Pub. Date: Mar. 13, 2008

(54) Composite Electrode Active Material for Non-Aqueous Electrolyte Secondary Battery or Non-Aqueous Electrolyte Electrochemical Capacitor and Method for Producing the Same

(76) Inventors: Hiroaki Matsuda, Osaka (JP); Sumihito Ishida, Osaka (JP); Hiroshi Yoshizawa, Osaka (JP)

Correspondence Address: MCDERMOTT WILL & EMERY LLP, 600 13TH STREET, NW, WASHINGTON, DC, 20005-3096, US

(21) Appl. No.: 11/665,471

(22) PCT Filed: Dec. 19, 2005
(86) PCT No.: PCT/JP05/23222

§ 371 Date: Apr. 16, 2007

(30) Foreign Application Priority Data
Dec. 24, 2004 (JP) 2004-374199

(51) Int. Cl. H01G 9/04; H01M 10/38; H01M 4/38

(52) U.S. Cl. 361/516; 427/77; 429/209; 429/218.1; 977/700

(57) ABSTRACT

Disclosed is a composite electrode active material for non-aqueous electrolyte secondary batteries or non-aqueous electrolyte electrochemical capacitors which contains a material A containing an element capable of forming an alloy with lithium, a material B containing carbon excluding carbon nanofiber, a catalyst element for promoting the growth of carbon nanofiber, and carbon nanofibers grown on at least one selected from the surface of the material A and the surface of the material B.

### TECHNICAL FIELD

The present invention relates to a composite electrode active material for use in non-aqueous electrolyte secondary batteries or non-aqueous electrolyte electrochemical capacitors and a method for producing the same. Specifically, the present invention relates to a composite electrode active material including a material with carbon nanofibers grown on the surface thereof. The composite electrode active material of the present invention provides non-aqueous electrolyte secondary batteries or non-aqueous electrolyte electrochemical capacitors having excellent charge/discharge characteristics and cycle characteristics.

### BACKGROUND ART

As electronic devices have been progressively made portable and cordless, there has been growing expectation for non-aqueous electrolyte secondary batteries that are small in size and light in weight and have a high energy density. At present, carbonaceous materials such as graphite come into practical use as negative electrode active materials for non-aqueous electrolyte secondary batteries. Graphite can theoretically absorb lithium in a proportion of one lithium atom to six carbon atoms.

Graphite has a theoretical capacity density of 372 mAh/g; however, the actual discharge capacity density is decreased to be approximately 310 to 330 mAh/g because of capacity loss due to the irreversible capacity, etc. In principle, it is difficult to obtain a carbonaceous material that can absorb or desorb lithium ions having a capacity density equal to or higher than the above-described capacity density.

Under the circumstance in which batteries having an ever higher energy density have been demanded, promising as negative electrode active materials having a high theoretical capacity density are Si, Sn and Ge that are capable of forming an alloy with lithium, and oxides and alloys of these. In particular, the use of cheap Si and oxides thereof has been widely examined. However, the volume change of these materials associated with absorption and desorption of lithium is very large. Because of this, expansion and contraction are repeated as a charge/discharge cycle is repeated, causing pulverization of the active material particles or reduction in conductivity between the particles. As a result, the degradation of the active material associated with repeated charge/discharge cycles becomes extremely great.

Under these circumstances, particles made of a composite material including a material capable of forming an alloy with lithium and a carbonaceous material have been devised (e.g., Patent Document 1). The charge/discharge capacity of the particles is greater than that of an active material singly composed of graphite, and the volume change rate associated with charge/discharge of the particles is smaller than that of an active material singly composed of a material capable of forming an alloy with lithium. However, repeated charge/discharge cycles cause volume changes in the composite material particles, resulting in crush, pulverization or reduction in conductivity between the particles. It is not considered therefore that sufficient cycle characteristic can be obtained.

One proposal suggests that the surface of the composite material particles be coated with a carbonaceous material in order to suppress the volume change of the above-described composite material particles due to repeated charge/discharge cycles and reduce crush or pulverization of the particles (e.g., Patent Document 2). This proposal intends to curb the expansion of the particles caused by absorption of lithium by virtue of the carbonaceous material covering the surface of the composite material particles.

In addition, with respect to a negative electrode for non-aqueous electrolyte secondary batteries using a carbonaceous material as an active material, another proposal suggests a technique to allow a catalyst to be carried on the surface of the carbonaceous material and then to grow carbon nanotubes therefrom (Patent Document 3). This proposal intends to enhance the conductivity between the particles of the carbonaceous material and moreover in the case of fabricating high-density electrode plates, to improve permeability of the electrolyte.

On the other hand, electrochemical capacitors using a polarizable electrode such as activated carbon for its positive electrode and negative electrode have a higher capacity compared with secondary batteries, and are excellent in cycle characteristics. For these advantages, electrochemical capacitors are used for back-up power sources for electronic equipment; however, the disadvantage thereof is that the energy density is low. This is because the electric charge is stored only in the surface of the electrode in the electrochemical capacitors. However, it is difficult to greatly improve the energy density of the electrochemical capacitors only by increasing the specific surface area of the electrode.

Patent Document 1: Japanese Laid-Open Patent Publication No. 2000-113885

Patent Document 2: Japanese Laid-Open Patent Publication No. 2002-216751

Patent Document 3: Japanese Laid-Open Patent Publication No. 2001-196064

### DISCLOSURE OF THE INVENTION

### Problems to Be Solved by the Invention

As described above, there have been examined proposals to use a material comprising an element capable of forming an alloy with lithium as an electrode active material for non-aqueous electrolyte secondary batteries. However, none of the proposals are considered to be satisfactory in curbing the degradation associated with repeated charge/discharge cycles, and the practical use thereof has not yet been achieved. For example, even when the surface of the particles made of a composite material of a material capable of forming an alloy with lithium and a carbonaceous material is coated with a carbonaceous material, it is impossible to control the volume change of the material capable of forming an alloy with lithium. Because of this, the particles expand due to absorption of lithium along with the coating layer composed of the carbonaceous material. Furthermore, when the charge/discharge cycle is repeated, the coating layer ruptures or exfoliates and the composite material particles are crushed and pulverized, causing reduction in the conductivity between the particles and degradation in charge/discharge characteristics. In view of the above, the techniques as proposed in Patent Documents 1 and 2 are not suitable for practical use.

Patent Document 3 proposes a negative electrode using an active material singly composed of a carbonaceous material. Hence, this document fails to provide a solution to a problem arising when such a material whose volume change is great as described above is used as an electrode active material.

### Means for Solving the Problems

The present invention proposes a composite electrode active material for use in non-aqueous electrolyte secondary batteries or non-aqueous electrolyte electrochemical capacitors comprising: a material A comprising an element capable of forming an alloy with lithium; a material B comprising carbon excluding carbon nanofiber; a catalyst element for promoting the growth of carbon nanofiber; and carbon nanofibers grown on at least one selected from a surface of the material A and a surface of the material B.

It is satisfactory that the catalyst element is carried on at least one selected the group consisting of the material A comprising an element capable of forming an alloy with lithium, the material B comprising carbon excluding carbon nanofiber, and the carbon nanofibers. For example, it is satisfactory that the catalyst element is carried on at least one end of the carbon nanofibers.

It is preferable that the element capable of forming an alloy with lithium is Si or/and Sn. Moreover, it is preferable that the catalyst element is at least one selected from the group consisting of Mn, Fe, Co, Ni, Cu and Mo.

The present invention further relates to a method for producing a composite electrode active material for use in non-aqueous electrolyte secondary batteries or non-aqueous electrolyte electrochemical capacitors, the method comprising the steps of: obtaining a composite material or a mixture comprising a material A comprising an element capable of forming an alloy with lithium and a material B comprising carbon; allowing a compound comprising a catalyst element for promoting the growth of carbon nanofiber to be carried on at least one selected from a surface of the material A and a surface of the material B; growing carbon nanofibers on at least one selected from the surface of the material A and the surface of the material B, while reducing the compound in a mixed gas of a carbon-containing gas and hydrogen gas; baking the composite material or the mixture comprising the material A and the material B with the carbon nanofibers grown thereon, at 400° C. or higher and 1600° C. or lower in an inert gas atmosphere.

The present invention further relates to a non-aqueous electrolyte secondary battery including a negative electrode comprising the above-described composite electrode active material, a positive electrode capable of charging and discharging lithium, a separator interposed between the negative electrode and the positive electrode, and a non-aqueous electrolyte.

The present invention further relates to a non-aqueous electrolyte electrochemical capacitor including a negative electrode comprising the above-described composite electrode active material, a positive electrode comprising a polarizable electrode material, a separator interposed between the negative electrode and the positive electrode, and a non-aqueous electrolyte.

### EFFECT OF THE INVENTION

According to the present invention, it is possible to obtain an active material having a charge/discharge capacity that exceeds the theoretical capacity of graphite. Moreover, the conductivity between the active material particles can be maintained even after the material A capable of forming an alloy with lithium undergoes a great change in volume. Hence, the composite electrode active material of the present invention suppresses the reduction in conductivity of the electrodes due to expansion and contraction of the material A comprising an element capable of forming an alloy with lithium, and thus provides a non-aqueous electrolyte secondary battery having a high charge/discharge capacity and excellent cycle characteristics.

Further, the carbon nanofibers contained in the composite electrode active material of the present invention have an electric double layer capacity, and the material A capable of forming an alloy with lithium has a pseudocapacitance due to insertion and extraction of lithium. Hence, the composite electrode active material of the present invention provides a non-aqueous electrolyte electrochemical capacitor having a high charge/discharge capacity and excellent cycle characteristics.

For example, in the case where both the material A capable of forming an alloy with lithium and the material B comprising carbon are in a particulate state, carbon nanofibers are grown on at least one selected from the particle surface of the material A and the particle surface of the material B to coat each particle with the carbon nanofibers. By allowing the carbon nanofibers to be in an intertwined state, the particles are connected with each other via the carbon nanofibers at a large number of points. This enables the conductivity between the active material particles to be maintained even when the volume of the material A is changed greatly. In this case, even when the material A undergoes repeated expansion and contraction associated with charge/discharge and the particles thereof are crushed or pulverized, the particles of the formed fine powder are kept connected electrically via the carbon nanofibers. Hence, the conductivity between the particles is not reduced as much as in the conventional case.

The carbon nanofibers may be grown on both the particle surface of the material A and the particle surface of the material B, or grown on either one of them. For example, in the case where the material A with carbon nanofibers grown on the particle surface thereof and the material B without carbon nanofibers grown on the surface thereof are mixed, the particles of the material A are intertwined with each other via the carbon nanofibers. The particles of the material B subsequently enter the spaces between the particles of the material A, and the material B also becomes electrically connected with the carbon nanofibers. As a result, even when the volume change has been occurred, the conductivity between the active material particles can be maintained. However, an effect of securing the conductivity between the active material particles is enhanced when the carbon nanofibers are grown on the particle surface of the material A and the particle surface of the material B, since there are a larger number of electrical connection points.

In the composite electrode active material of the present invention, dissimilarly to the proposal of the Patent Document 2, in which the particles are covered with a rigid coating layer composed of a carbonaceous material, the particles are covered with layered carbon nanofibers having a cushioning effect. Structured as such, even when the particles of the material A have expanded, the carbon nanofiber layer can absorb the stress due to expansion. Accordingly, this suppresses breakage and exfoliation of the carbon nanofiber layer due to expansion of the material A and prevents the adjacent particles from being pushed strongly against each other. On the other hand, even when the particles of the material A have contracted, the damage to the conductivity between the adjacent particles can be suppressed since the carbon nanofibers are intertwined with each other.

Evidence is obtained that the growth rate of carbon nanofiber is significantly high when carbon nanofibers are grown on a composite material or a mixture of the material A and the material B comprising carbon. In this case, the growth rate of carbon nanofiber is extremely higher than that when the carbon nanofibers are grown exclusively on the material A. Hence, according to the present invention, it is possible to shorten the time required for growing carbon nanofibers. As a result, a more efficient production method of an electrode active material including the step of growing carbon nanofibers can be achieved, and thus the production efficiency of the electrode active material is significantly improved.

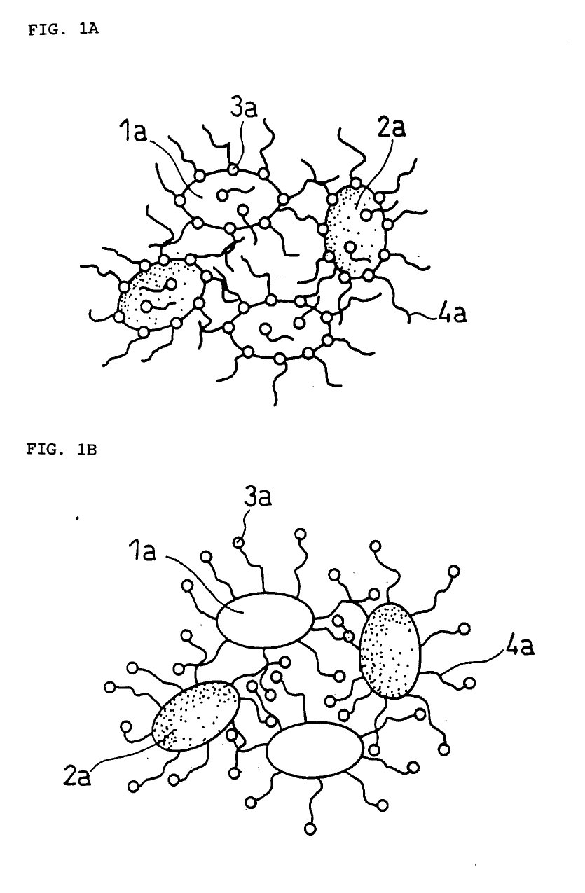

### BRIEF DESCRIPTION OF THE DRAWINGS

[FIG. 1A]

A schematic view illustrating a structure of a first example of a composite electrode material of the present invention.

[FIG. 1B]

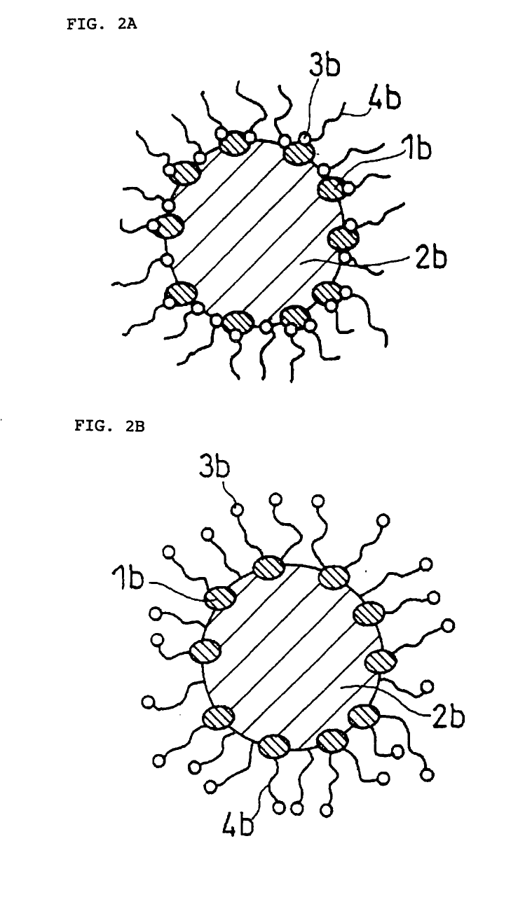

A schematic view illustrating another structure of the first example of a composite electrode material of the present invention.

[FIG. 2A]

A schematic view illustrating a structure of a second example of a composite electrode material of the present invention.

[FIG. 2B]

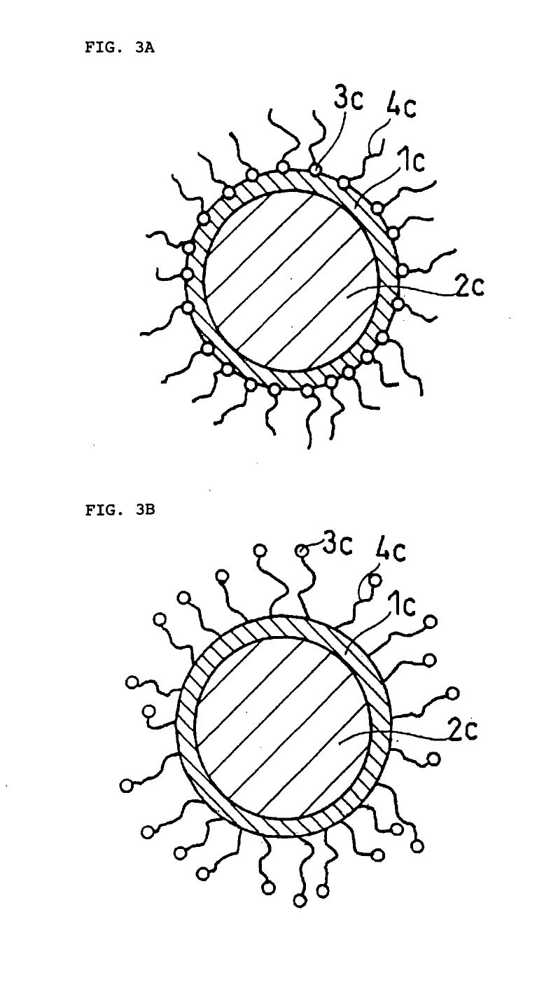

A schematic view illustrating another structure of the second example of a composite electrode material of the present invention.

[FIG. 3A]

A schematic view illustrating a structure of a third example of a composite electrode material of the present invention.

[FIG. 3B]

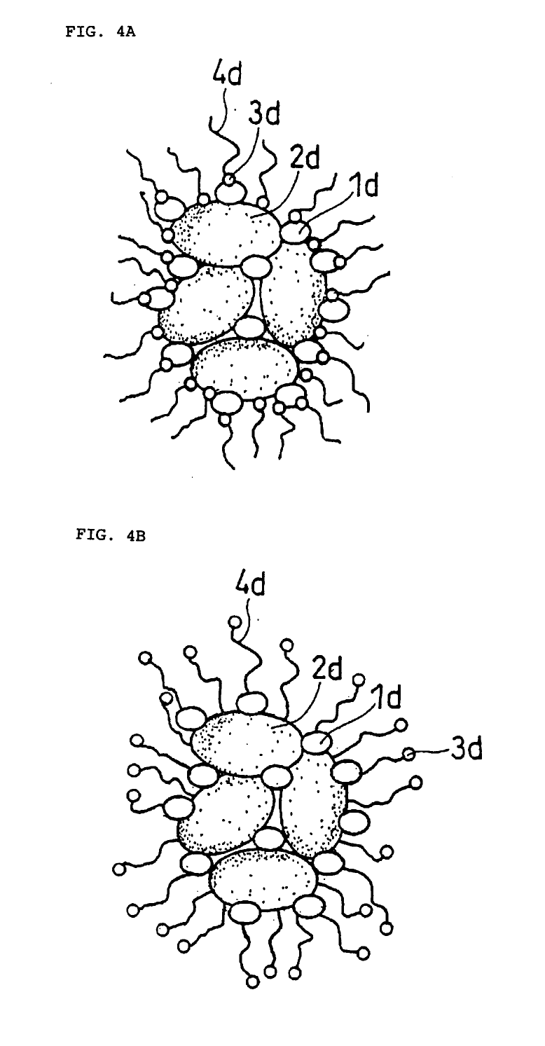

A schematic view illustrating another structure of the third example of a composite electrode material of the present invention.

[FIG. 4A]

A schematic view illustrating a structure of a fourth example of a composite electrode material of the present invention.

[FIG. 4B]

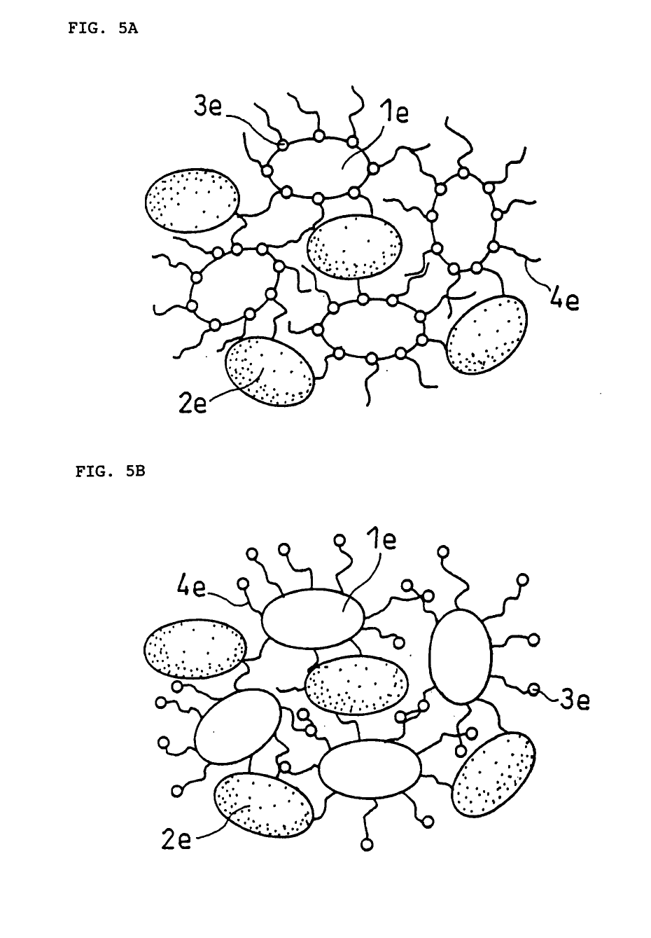

A schematic view illustrating another structure of the fourth example of a composite electrode material of the present invention.

[FIG. 5A]

A schematic view illustrating a structure of a fifth example of a composite electrode material of the present invention.

[FIG. 5B]

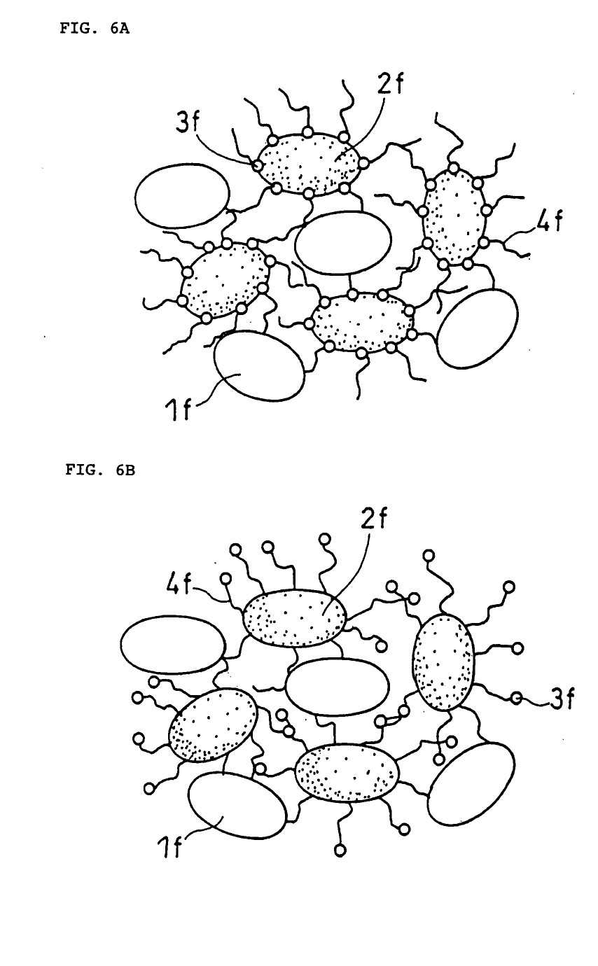

A schematic view illustrating another structure of the fifth example of a composite electrode material of the present invention.

[FIG. 6A]

A schematic view illustrating a structure of a sixth example of a composite electrode material of the present invention.

[FIG. 6B]

A schematic view illustrating another structure of the sixth example of a composite electrode material of the present invention.

### BEST MODE FOR CARRYING OUT THE INVENTION

A composite electrode active material according to the present invention includes a material A comprising an element capable of forming an alloy with lithium, a material B comprising carbon excluding carbon nanofiber, a catalyst element for promoting the growth of carbon nanofiber, and carbon nanofibers grown on at least one selected from a surface of the material A or a surface of the material B. The composite electrode active material includes a material exclusively composed of the material A, the material B, the catalyst element and the carbon nanofibers, and a material additionally containing other components. The other components are exemplified by a material capable of absorbing or desorbing lithium other than the materials A and B, and impurities.

The composite negative electrode active material as described above can be obtained by allowing the carbon nanofibers to grow on the surface of the material A and/or the material B carrying the catalyst element for promoting the growth of carbon nanofiber. At least one end of the carbon nanofibers is bonded to the surface of the material A and/or the material B, and typically only one end is bonded thereto. The type of bond includes a chemical bond and a bond by intermolecular force, but excludes a bond involving the intermediary of a resin component. Herein, the chemical bond includes an ionic bond and a covalent bond.

The carbon nanofibers are directly bonded to the surface of the material A and/or the material B, which serves as a starting point of the growth. It is preferable that at the bonding sites of the carbon nanofibers and the material A, the component element of the material A and the carbon as a component of the carbon nanofibers form a compound. It is further preferable that the bonding sites of the carbon nanofibers and the material B, the carbon as a component of the material B and the carbon as a component of the carbon nanofibers form a covalent bond.

The material A comprising an element capable of forming an alloy with lithium may be exclusively composed of an element capable of forming an alloy with lithium such as an elementary substance of an element capable of forming an alloy with lithium, or may additionally include an element that does not form an alloy with lithium. The material A may be used singly or in combination of two or more materials.

Although not specifically limited, the element capable of forming an alloy with lithium is exemplified by Al, Si, Zn, Ge, Cd, Sn and Pb. These may be contained singly in the material A or alternatively two or more may be contained in the material A. It should be noted that Si and Sn are particularly preferable as the element capable of forming an alloy with lithium in that they make it possible to obtain a material capable of absorbing a large amount of lithium and are easily available. There can be used various materials as the material A containing Si, Sn and the like, including elementary Si, elementary Sn, an oxide such as SiOₓ (0<x<2) and SnOₓ (0<x≦2), and an alloy containing a transition metal element such as an Ni—Si alloy, a Ti—Si alloy, an Mg—Sn alloy and an Fe—Sn alloy.

Although the material A may be of any form as long as it can form a composite material with the material B, it is preferably in a particulate state or in a state of a layer covering the particle of the material B.

There can be used various materials as the material B comprising carbon excluding carbon nanofiber, including graphite such as natural graphite and artificial graphite, carbon black, coke, and active carbon fibers. The material B may be used singly or in combination of two or more materials.

Although the material B may be of any form as long as it can form a composite material with the material A, it is preferably in a particulate state or in a state of a layer covering the particles of the material A.

Although not specifically limited, the catalyst element for promoting the growth of carbon nanofiber usable herein is Mn, Fe, Co, Ni, Cu, Mo or the like. These may be used singly or in combination of two or more. In the composite electrode active material, the catalyst element may be in a metallic state or in a state of a compound such as an oxide. Further, when the catalyst element is in a metallic state, it may be an elementary substance or be formed into an alloy. Furthermore, when the catalyst element is formed into an alloy, the alloy may be that of the catalyst element and the other metallic element. In addition, two or more states of catalyst element among those described above may be present concomitantly in the composite electrode active material. It should be noted that the catalyst element is preferably present in a particulate state in the composite electrode active material.

In the case where the catalyst element in a particulate state, it is preferable that the particles of the catalyst element (hereinafter referred to as catalyst particles) have a particle size of 1 nm to 1000 nm. It is extremely difficult to form catalyst particles having a particle size of less than 1 nm. On the other hand, when the particle size of catalyst particles exceeds 1000 nm, the formed catalyst particles are extremely nonuniform in size. As a result, it becomes difficult to grow carbon nanofibers, or a composite electrode active material excellent in conductivity may not be obtained. Herein, a particle size of the catalyst particles can be measured using a scanning electron microscope (SEM) and the like. Further, a mean particle size can be obtained by measuring particle sizes of arbitrarily selected 20 to 100 catalyst particles and then determining the mean value thereof.

The catalyst element may be carried on at least one selected from the group consisting of the material A comprising an element capable of forming an alloy with lithium, the material B comprising carbon excluding carbon nanofiber, and the carbon nanofibers. Herein, in the case where the catalyst element is carried on the material A, it is satisfactory that the catalyst element is present at least in the surface of the material A; however, it may additionally be present inside the material A. And in the case where the catalyst element is carried on the material B, it is satisfactory that the catalyst element is present at least in the surface of the material B; however, it may additionally be present inside the material B. Further, in the case where the catalyst element is carried on the carbon nanofibers, it is satisfactory that the catalyst element is carried on at least one end of the carbon nanofibers.

When the catalyst element is not separated from the material A and/or the material B after the growth of carbon nanofiber is completed, the catalyst element is located at the root of the carbon nanofibers bonded to the surface of the material A and/or the material B, namely, the fixed end thereof. On the other hand, when the catalyst element is separated from the material A and/or the material B as the carbon nanofibers grow, the catalyst element is usually located at the tip of the carbon nanofibers, namely, the free end thereof.

In the composite electrode active material, the carbon nanofiber with the catalyst element being present at the fixed end thereof and the carbon nanofiber with the catalyst element being present at the free end thereof may be present concomitantly with each other. Further, it is satisfactory that at least one end of the carbon nanofibers is bonded to the surface of the material A and/or the material B; however, both ends thereof may be bonded to the surface of the material A and/or the material B. And in some cases, in the course of the growth of carbon nanofiber, the catalyst element is incorporated into the interior of the fiber.

The length of the carbon nanofibers grown from the surface of the material A and/or the material B is preferably 1 nm to 1000 μm, and more preferably 500 nm to 10 μm. When the length of the carbon nanofibers is less than 1 nm, the effects of improving the conductivity of the electrode and absorbing expansion stress of the material A are reduced; and when greater than 1000 μm, the density of the active material in the electrode decreased, and a high energy density cannot be obtained. Further the fiber diameter of the carbon nanofibers is preferably 1 nm to 1000 nm, and more preferably 50 nm to 300 nm. Herein, the fiber length and the fiber diameter of the carbon nanofibers can be measured using a scanning electron microscope (SEM) and the like. Further, a mean length and a mean diameter can be obtained by, for example, measuring fiber lengths and fiber diameters of arbitrarily selected 20 to 100 carbon nanofibers and then determining a mean value thereof.

Although the carbon nanofibers may be in any state, the state includes, for example, a tubular state, an accordion state, a plate state and a herringbone state. The carbon nanofibers may exclusively include at least one of these or may include two or more, or may additionally include carbon nanofibers in other states.

Next, an embodiment of the composite electrode active material of the present invention will be described below with reference to the drawings. It is to be understood that the composite electrode active material of the present invention includes various embodiments and is not limited to the embodiment below.

FIG. 1A and FIG. 1B are schematic views illustrating a first example of the composite electrode active material of the present invention.

The material Ala comprising an element capable of forming an alloy with lithium and the material B2a comprising carbon each have a substantially same particle size. The carbon nanofibers 4a are grown with catalyst particles as a starting point. In FIG. 1A, the material A and the material B each carry catalyst particles 3a. In FIG. 1B, the catalyst particles are present at the tips of the grown carbon nanofibers 4a. The carbon nanofibers 4a grown on the particle surface of both the material A1a and the material B2a are intertwined with each other.

In the case where the composite electrode active materials as illustrated in FIG. 1A and FIG. 1B are to be obtained, a mean particle size of the particles of the material A is preferably 0.1 to 100 μm, although not specifically limited thereto. And a mean particle size of the particles of the material B is preferably 0.1 to 100 μm, although not specifically limited thereto.

FIG. 2A and FIG. 2B are schematic views illustrating a second example of the composite electrode active material of the present invention.

The fine particles of the material A1b comprising an element capable of forming an alloy with lithium are carried on the surface of the material B2b comprising carbon. The carbon nanofibers 4a are grown with catalyst particles as a starting point. In FIG. 2A, the finer particles of the catalyst particles 3b are carried on the surface of both the fine particles of the material A1b and the material B2b, and the carbon nanofibers 4b are grown with the catalyst particles as a starting point. In FIG. 2B, the catalyst particles are present at the tips of the grown carbon nanofibers 4b. The fine particles of the material A1b are embedded in the cavities of the material 2b.

In the case where the composite-electrode active materials as illustrated in FIG. 2A and FIG. 2B are to be obtained, a mean particle size of the particles of the material A is preferably 0.001 to 50 μm, although not specifically limited thereto. And a mean particle size of the particles of the material B is preferably 0.1 to 100 μm, although not specifically limited thereto.

FIG. 3A and FIG. 3B are schematic views illustrating a third example of the composite electrode active material of the present invention.

The material A1c comprising an element capable of forming an alloy with lithium in a layer state covers the particle surface of the material B2c comprising carbon. In FIG. 3A and FIG. 3B, the entire particle surface of the material B2c is covered with a layer of the material A1c; however, in some cases the particle surface of the material B2c is partly covered. In FIG. 3A, the catalyst particles 3c are carried on the particles of the material B2c coated with the material A1c, and the carbon nanofibers 4c are grown with the catalyst particles as a starting point. In FIG. 3B, the catalyst particles are present at the tips of the grown carbon nanofibers 4a.

In the case where the composite electrode active materials as illustrated in FIG. 3A and FIG. 3B are to be obtained, a mean particle size of the particles of the material B is preferably 0.1 to 100 μm, although not specifically limited thereto. And a thickness of the coating layer of the material A is preferably 0.001 to 50 μm, although not specifically limited thereto. When the thickness of the coating layer is less than 0.001 μm, it is difficult to realize a high charge/discharge capacity. On the other hand, when the thickness of the coating layer is greater than 50 μm, the volume change of the active material particles due to charge/discharge is increased, and the particles are easily crushed.

In the case where the composite electrode active materials as illustrated in FIGS. 2 to 3 are to be obtained, for example, prior to the step of allowing the catalyst particles to be carried, the particles of the material B are mixed with a solution of the material A or its precursor and then dried to cause the material A or its precursor to be carried on the material B. The precursor of the material A is transformed into the material A by subsequent heating. Alternatively, for example, prior to the step of allowing the catalyst particles to be carried, the particles of the material B and the material A may be sufficiently mixed together beforehand while shearing force is being applied thereto.

In the case where the particles of the composite material constituted of the material A and the material B as illustrated in FIGS. 2 to 3, a mean particle size of the particles is preferably 1 to 100 μm, although not specifically limited thereto. When the particles of the composite material is less than 1 μm, the specific surface area of the negative electrode active material is increased, and the irreversible capacity during an initial charge/discharge operation may be increased. On the other hand, when the particle size of the composite material particles is greater than 100 μm, it sometimes becomes difficult to fabricate a negative electrode having a uniform thickness.

FIG. 4A and FIG. 4B are schematic views illustrating a fourth example of the composite electrode active material of the present invention.

The fine particles of the material A1d comprising an element capable of forming an alloy with lithium and the particles of the material B2d comprising carbon being larger than those are agglomerated to form secondary particles (composite material particles). In FIG. 4A and the FIG. 4B, the particles of the material B2d are larger than the particles of the material A1d; however, in some cases the particles of the material A1d are larger than the particles of the material B2d. In FIG. 4A, the catalyst particles 3d are carried on the secondary particles, and the carbon nanofibers 4d are grown with the catalyst particles as a starting point. In FIG. 4B, the catalyst particles are present at the tips of the grown carbon nanofibers 4d. The carbon nanofibers 4d have a function of securing electronic conduction inside the secondary particles as well as electronic conduction between the secondary particles.

In the case where the composite electrode active materials as illustrated in FIG. 4A and FIG. 4B are to be obtained, a mean particle size of the particles of the material A is preferably 0.01 to 100 μm, although not specifically limited thereto. And a mean particle size of the particles of the material B is preferably 0.1 to 100 μm, although not specifically limited thereto. Further, when the particles of the material A1d are larger than the particles of the material B2d, a mean particle size of the particles of the material A is preferably 0.1 to 100 μm, although not specifically limited thereto; and a mean particle size of the particles of the material B is preferably 0.01 to 100 μm, although not specifically limited thereto. Moreover, a mean particle size of the secondary particles (the composite material particles) is preferably 1 to 100 μm, although not specifically limited thereto.

In the case where the composite electrode active materials as illustrated in FIG. 4A and FIG. 4B are to be obtained, for example, prior to the step of allowing the catalyst particles to be carried, the material A and the material B are sufficiently mixed beforehand while shearing force is being applied thereto. In such an operation, it is preferable to allow a mechanochemical reaction to proceed between the material A and the material B.

FIG. 5A and FIG. 5B are schematic views illustrating a fifth example of the composite electrode active material of the present invention.

In FIG. 5A, the catalyst particles 3e are carried on the material Ale comprising an element capable of forming an alloy with lithium, and the carbon nanofibers 4e are grown with the catalyst particles as a starting point. In FIG. 5B, the catalyst particles are present at the tips of the grown carbon nanofibers 4e. The particles of the material B2c comprising carbon are incorporated in the space among the composite particles composed of the material Ale, the catalyst particles 3c and the carbon nanofibers 4e.

The composite electrode active materials as illustrated in FIG. 5A and FIG. 5B are obtained by, for example, after allowing the catalyst particles to be carried only on the material A to grow carbon nanofibers, and then wet mixing the resultant composite particles and the material B in a dispersion medium.

FIG. 6A and FIG. 6B are schematic views illustrating a sixth example of the composite negative electrode active material of the present invention.

In FIG. 6A, the catalyst particles 3f are carried on the material B2f comprising carbon, and the carbon nanofibers 4f are grown with the catalyst particles as a starting point. In FIG. 6B, the catalyst particles are present at the tips of the grown carbon nanofibers 4f. The particles of the material Alf comprising an element capable of forming an alloy with lithium are incorporated in the space among the composite particles composed of the material B2f, the catalyst particles 3f and the carbon nanofibers 4f.

The composite electrode active materials as illustrated in FIG. 6A and FIG. 6B are obtained by, for example, after allowing the catalyst particles to be carried only on the material B to grow carbon nanofibers, and then wet mixing the resultant composite particles and the material A in a dispersion medium.

It is preferable that mixing for obtaining the composite negative electrode active materials as illustrated in FIGS. 5 to 6 is carried out in a below-described step of preparing a material mixture slurry for fabricating an electrode. It is difficult to prepare a homogeneous material mixture slurry that contains the particles with carbon nanofibers grown thereon; however, mixing the particles with no carbon nanofibers grown thereon facilitates the preparation of a homogeneous material mixture slurry.

In the composite electrode active material, the weight proportion of the material A to the total weight of the material A comprising an element capable of forming an alloy with lithium and the material B comprising carbon is preferably 10% by weight to 90% by weight, and more preferably 20% by weight to 60% by weight. When the proportion of the material A is less than 10% by weight, a high charge/discharge capacity cannot be obtained. When the proportion of the material A exceeds 90% by weight, the volume change of the active material particles is increased, and crush of the particles and reduction in conductivity between the particles may occur.

Compared with in the case where the carbon nanofibers are grown only on the material A comprising an element capable of forming an alloy with lithium, in the case where the carbon nanofibers are grown on a composite material or a mixture of the material A and the material B comprising carbon, the growth rate of carbon nanofiber is significantly high. Such an effect of improving the growth rate of carbon nanofiber can be obtained regardless of the weight proportion of the material B. Therefore, as long as the weight proportion of the material B to the total weight of the material A and the material B is in the range from 10% by weight to 90% by weight, a substantially similar effect of improving the growth rate of carbon nanofiber can be obtained.

A method for obtaining a composite material or a mixture of the material A comprising an element capable of forming an alloy with lithium and the material B comprising carbon are exemplified by the following methods, although other various methods may be selected:

(i) a simple mixing method of mixing the material A and the material B with a mortar, etc;

(ii) a method of utilizing a mechanochemical reaction in which mechanical shearing force is applied to the material A and the material B to obtain composite material particles (e.g., a milling method);

(iii) a method of attaching the material A onto the surface of the material B by vapor deposition, plating, etc;

(iv) a method of immersing the material B in a precursor solution of the material A and then treating the precursor of the material A attached onto the surface of the material B; and

(v) a method of carbonizing a mixture of the material A and a carbon precursor.

In the case where no catalyst element is present, the growth of carbon nanofiber is not observed. For this reason, in order to obtain a composite electrode active material of the present invention, it is necessary to allow a catalyst element to be carried on a composite material or a mixture containing the material A and the material B. A method for allowing a catalyst element to be carried on a composite material or a mixture containing the material A and the material B is not specifically limited. However, it is easier to allow a compound containing a catalyst element to be carried than to allow a simple substance of a catalyst element. It is preferable that the catalyst element is in a metallic state until the growth of carbon nanofiber is completed. The compound containing the catalyst element is therefore reduced to be in a metallic state and formed into catalyst particles before the growth of carbon nanofiber starts.

Although not specifically limited, the compound containing a catalyst element is exemplified by an oxide, a carbide, a nitrate and the like. Among these, a nitrate is preferably used. Examples of the nitrate include nickel nitrate hexahydrate, cobalt nitrate hexahydrate, iron nitrate nonahydrate, copper nitrate trihydrate, manganese nitrate hexahydrate and hexaammonium heptamolybdate tetrahydrate. Among these, a nickel nitrate and a cobalt nitrate are preferably used.

The compound containing a catalyst element may be mixed as it is in a solid state with a composite material or a mixture containing the material A and the material B; however, the compound is preferably mixed in a solution state, in which it is dissolved in a solvent, with the composite material or the mixture containing the material A and the material B. As the solvent, water as well as an organic solvent such as ethanol, isopropyl alcohol, toluene, benzene, hexane and tetrahydrofuran may be used. The solvent may be used singly or in combination of two or more as a mixture solvent.

In the composite electrode active material of the present invention, the weight proportion of the catalyst element to the total weight of the catalyst element, the material A and the material B is preferably 0.01% by weight to 10% by weight, and more preferably 0.1% by weight to 5% by weight. In the case of using a compound containing a catalyst element also, it is preferable to adjust the weight of the catalyst element contained in the compound so as to fall within the above-described range. When the proportion of the catalyst element is less than 0.01% by weight, it requires a long time to grow carbon nanofibers, causing a reduction in production efficiency. On the other hand, when the proportion of the catalyst element is greater than 10% by weight, nonuniform carbon nanofibers having a large fiber diameter are grown due to agglomeration of the catalyst particles. This makes it impossible to improve the conductivity between the active material particles efficiently, and leads to a reduction in the density of the active material in the negative electrode.

In the case of a composite electrode active material for use in non-aqueous electrolyte secondary batteries, the weight proportion of the carbon nanofibers to the total weight of the catalyst element, the material A, the material B, and the carbon nanofibers is preferably 5% by weight to 70% by weight, and particularly preferably 10% by weight to 40% by weight. When the proportion of the carbon nanofibers is less than 5% by weight, the effects of improving the conductivity between the active material particles and absorbing expansion stress of the active material are reduced. On the other hand, when the proportion of the carbon nanofibers is greater than 70% by weight, the density of the active material in the negative electrode is reduced.

In the case of a composite electrode active material for use in non-aqueous electrolyte electrochemical capacitors, the weight proportion of the carbon nanofibers to the total weight of the catalyst element, the material A, the material B, and the carbon nanofibers is preferably 50% by weight to 95% by weight, and particularly preferably 70% by weight to 90% by weight.

The conditions for growing carbon nanofibers will be hereinafter described.

When a composite material or a mixture containing the material A carrying a catalyst element and the material B is introduced into a high temperature atmosphere that contains a raw material gas for carbon nanofiber, the growth of carbon nanofiber starts to proceed. For example, a composite material or a mixture containing the material A and the material B is placed in a ceramic reaction vessel, and the temperature is elevated to high temperatures of 100 to 1000° C., preferably 300 to 700° C. in an inert gas or a gas having a reducing power. Thereafter, a raw material gas for carbon nanofiber is introduced into the reaction vessel to grow carbon nanofibers for a duration of, for example, 1 minute to 5 hours. When the temperature inside the reaction vessel is lower than 100° C., the growth of carbon nanofiber does not occur or the growth is too slow, and thus the productivity is impaired. When the temperature inside the reaction vessel exceeds 1000° C., decomposition of the reaction gas is promoted, and thus the production of the carbon nanofibers becomes difficult.

Preferred as the raw material gas is a mixed gas composed of a carbon-containing gas and hydrogen gas. Usable as the carbon-containing gas are methane, ethane, ethylene, butane, acetylene, carbon monoxide and the like. The mixing ratio of the carbon-containing gas to hydrogen gas is preferably 0.2:0.8 to 0.8:0.2 in terms of molar ratio (volume ratio).

The reduction of a compound containing a catalyst element proceeds while the temperature is elevated in an inert gas or a gas having a reducing power. When catalyst particles in a metallic state are not formed on the surface of the material A or the material B during the temperature elevation, the proportion of hydrogen gas is controlled to be slightly higher. This makes it possible to allow the reduction of catalyst element to proceed in parallel with the growth of carbon nanotube.

In order to terminate the growth of carbon nanofiber, the mixed gas composed of a carbon-containing gas and hydrogen gas is replaced with an inert gas, and the interior of the reaction vessel is cooled down to room temperature. Subsequently, the composite material or the mixture of the material A and the material B with the carbon nanofibers grown thereon is baked in an inert gas atmosphere at 400° C. or higher and 1600° C. or lower, preferably at 600° C. or higher and 1500° C. or lower, for a duration of, for example, 10 minutes to 5 hours. As a result of the baking as such, the irreversible reaction between the electrolyte and the carbon nanofibers that proceeds during an initial charge operation of the battery can be suppressed, and an excellent charge/discharge efficiency can be attained.

When such a baking step is not carried out, or the baking temperature is lower than 400° C., the above described irreversible reaction cannot be suppressed and the charge/discharge efficiency of the battery may be degraded. When the baking temperature exceeds 1600° C., the reaction between the carbon nanofibers and the material A proceeds, causing a reduction in discharge characteristics. For example, in the case where the material A contains silicon oxide, when the temperature exceeds 1600° C., the carbon nanofibers and silicon oxide react with each other to form SiC, which is electrochemically inactive and of high resistance.

Next, the negative electrode for use in non-aqueous electrolyte secondary batteries and non-aqueous electrolyte electrochemical capacitors containing the above-described composite electrode active material will be described below. The composite electrode active material of the present invention is suitably applicable for producing a negative electrode including a negative electrode material mixture containing a resin binder and a negative electrode current collector carrying the same.

The negative electrode material mixture may contain components including a conductive agent, a thickener, a conventionally known negative electrode active material (graphite, oxides, alloys, etc.) in addition to the composite electrode active material and the resin binder as long as the effects of the present invention are not significantly impaired. As the binder, fluorocarbon resins such as polyvinylidene fluoride (PVDF) and polytetrafluoroethylene (PTFE), rubber-like resins such as styrene-butadiene rubber (SBR) and polyacrylic acid derivative rubber, and the like are preferably used. As the conductive agent, carbonaceous materials such as carbon black including acetylene black, graphite and carbonfibers, and the like are preferably used. As the thickener, carboxymethyl cellulose (CMC), polyethylene oxide (PEO), and the like are used.

The negative electrode material mixture is mixed with a liquid component to be formed into slurry. The slurry thus obtained is applied on both sides of the current collector made of a Cu foil and the like, and then dried. As the liquid component, water and organic solvents such as N-methyl-2-pyrrolidone (NMP) and N, N-dimethyl acetamide (DMA) may be used. Thereafter, the electrode material mixture carried on the current collector is rolled together with the current collector and the rolled product is cut to a predetermined size to obtain a negative electrode. The method described herein is only an example, and the negative electrode may be fabricated by any other methods.

The negative electrode thus obtained, a positive electrode and a separator are used to constitute an electrode assembly. As the separator, a microporous film made of polyolefin resin such as polyethylene and polypropylene is preferably used, although it is not limited thereto.

The positive electrode for non-aqueous electrolyte secondary batteries is not specifically limited; however, there is preferably used, for example, a positive electrode comprising a lithium composite oxide serving as a positive electrode active material. As the lithium composite oxide, a lithium cobalt oxide (for example, LiCoO₂), a lithium nickel oxide (for example, LiNiO₂), a lithium manganese oxide (for example, LiNi₂O₄), and an oxide including at least one transition metal element selected from V, Cr, Mn, Fe, Co, Ni and the like are preferably used. Herein, it is preferable that the lithium composite oxide includes another element such as Al and Mg in addition to the transition metal element as a main component. As the current collector of the positive electrode, an Al foil is preferably used.

It is preferable that a positive electrode for use in non-aqueous electrolyte electrochemical capacitors includes a polarizable electrode material. As the polarizable electrode material, a carbonaceous material having a large specific surface area such as activated carbon is preferably used. The positive electrode may further include a material capable of charging/discharging lithium in addition to the polarizable electrode material. As a current collector of the positive electrode, an Al foil is preferably used.

The electrode assembly is housed together with a non-aqueous electrolyte in a case. For the non-aqueous electrolyte, there is generally used a non-aqueous solvent in which a lithium salt is dissolved. The non-aqueous electrolyte may further contain an additive such as vinylene carbonate (VC) and cyclohexylbenzene (CHB).

The lithium salt is not specifically limited; however, there are preferably used, for example, LiPF₆, LiClO₄, LiBF₄ and the like. The lithium salt may be used singly or in combination of two or more.

The non-aqueous solvent is not specifically limited; however, there are preferably used, for example, a carbonic acid ester such as ethylene carbonate (EC), propylene carbonate (PC), dimethyl carbonate (DMC), diethyl carbonate (DEC) and ethyl methyl carbonate (EMC), and γ-butyrolactone (GBL), tetrahydrofuran (THF), 1,2-dimethoxyethane (DME) and the like. The non-aqueous solvent is preferably used in combination of two or more as a mixture solvent.

The shape and the size of the non-aqueous electrolyte secondary battery and the non-aqueous electrolyte electrochemical capacitor are not specifically limited, and may be of various forms such as a cylindrical type, a rectangular type and a coin type.

Next, the present invention will be described below in further detail with reference to Examples, but it should be understood that the scope of the present invention is not limited to the examples below.

### EXAMPLE 1

Herein, silicon monoxide (SiO) was used as the material A comprising an element capable of forming an alloy with lithium, and artificial graphite was used as the material B comprising carbon.

100 parts by weight of silicon monoxide particles (reagent manufactured by Wako Pure Chemical Industries, Ltd.) obtained by grounding and classifying beforehand so as to have a mean particle size of 10 μm and 100 parts by weight of artificial graphite (manufactured by TIMCAL Ltd., SLP30, mean particle size 16 μm) were dry mixed in a mortar for 10 minutes.

100 parts by weight of the resultant mixture was mixed with a solution obtained by dissolving 1 part by weight of nickel nitrate (II) hexahydrate (guaranteed reagent) manufactured by Kanto Chemical Co., Inc in deionized water. A mixture of the silicon monoxide particles, the artificial graphite and the nickel nitrate solution was stirred for one hour and then the water was removed with an evaporator to allow nickel nitrate to be carried on the respective surfaces of the silicon monoxide particles and the artificial graphite particles.

A mixture of the silicon monoxide particles and the artificial graphite particles carrying nickel nitrate was placed in a ceramic reaction vessel, and the temperature was raised to 550° C. in the presence of helium gas. Thereafter, the helium gas was replaced with a mixed gas composed of 50% by volume of hydrogen gas and 50% by volume of methane gas, and the temperature was held at 550° C. for 10 minutes to reduce the nickel nitrate (II) and grow carbon nanofibers. The mixed gas was then replaced with helium gas and the interior of the reaction vessel was cooled down to room temperature, whereby a composite electrode active material was obtained.

Thereafter, the composite negative electrode active material was heated to 1000° C. in argon gas, and then baked at 1000° C. for one hour to give a composite electrode active material A.

As a result of analysis of the composite electrode active material A using an SEM, it was found that carbon nanofibers having a fiber diameter of approximately 80 nm and a length of approximately 100 μm cover the respective surfaces of the silicon monoxide particles and the graphite particles. The weight proportion of the grown carbon nanofibers to the whole composite electrode active material was approximately 20% by weight. Moreover, the nickel nitrate was reduced to metallic nickel to be formed into catalyst particles having a particle size of 0.1 μm.

### EXAMPLE 2

The same operations as in Example 1 were carried out except that the amount of artificial graphite with respect to 100% by weight of silicon monoxide particles was decreased to 20% by weight, whereby a composite negative electrode active material B as illustrated in FIG. 1 was obtained. The fiber diameter and the fiber length of the grown nanofibers, the weight proportion of the carbon nanofibers to the whole composite electrode active material and the particle size of the catalyst particles were substantially the same as those in Example 1.

### EXAMPLE 3

100 parts by weight of artificial graphite (manufactured by TIMCAL Ltd., SLP30, mean particle size 16 μm) and 110 parts by weight of tin acetate (II) (manufactured by Kanto Chemical Co., Inc., first class reagent) are mixed together with an aqueous acetic acid solution. The resultant mixture was stirred for one hour and then the acetic acid and the water were removed with an evaporator to allow tin acetate (II) to be carried on the surface of the graphite particles.

The graphite particles carrying tin acetate were placed in a ceramic reaction vessel, and the temperature was raised to 400° C. in the presence of argon gas. Thereafter, the temperature was held at 400° C. for 10 hours to reduce the tin acetate (II). The interior of the reaction vessel was then cooled down to room temperature, whereby composite material particles of graphite and tin oxide were obtained.

As a result of analysis of the composite material particles thus obtained using an SEM, an XRD, an EPMA and the like, it was found that particles of SnOₓ (0<x≦2) having a particle size of approximately 1 μm were carried on the surface of the graphite particles. The weight proportion of the SnOₓ to the whole composite material particles was approximately 50% by weight.

The same operations as in Example 1 were carried out except that the above-described composite material particles of graphite and SnOₓ were used in place of the dry mixture of silicon monoxide particles and artificial graphite, to allow nickel nitrate to be carried and carbon nanofibers to grow, whereby a composite electrode active material C as illustrated in FIG. 2 was obtained. The fiber diameter and the fiber length of the grown nanofibers, the weight proportion of the carbon nanofibers to the whole composite negative electrode active material and the particle size of the catalyst particles were substantially the same as those in Example 1.

### EXAMPLE 4

The same operations as in Example 3 were carried out except that the amount of tin acetate (II) with respect to 100 parts by weight of artificial graphite was decreased to 20 parts by weight, whereby composite material particles of graphite and tin oxide were obtained.

As a result of analysis of the composite material particles thus obtained using an SEM, an XRD, an EPMA and the like, it was found that a coating layer (thickness approximately 0.5 μm) of SnOₓ (0<x≦2) covered the surface of the graphite particles. The weight proportion of the SnOₓ to the whole composite material particles was approximately 15% by weight. Herein, it was observed that the SnOₓ (0<x≦2) did not completely cover the entire surface of the graphite particles, and the graphite was partially exposed to the surface.

The same operations as in Example 1 were carried out except that such composite material particles were used, to allow nickel nitrate to be carried and carbon nanofibers to grow, whereby a composite electrode active material D as illustrated in FIG. 3 was obtained. The fiber diameter and the fiber length of the grown nanofibers, the weight proportion of the carbon nanofibers to the whole composite electrode active material and the particle size of the catalyst particles were substantially the same as those in Example 1.

### EXAMPLE 5

100 parts by weight of artificial graphite (manufactured by TIMCAL Ltd., SLP30, mean particle size 16 μm) and 50 parts by weight of silicon monoxide particles (manufactured by Wako Pure Chemical Industries, Ltd., reagent) obtained by grounding and classifying beforehand so as to have a mean particle size of 10 μm were placed in the interior of the reaction chamber of a planetary ball milling apparatus, and then subjected to 24-hour grounding and mixing in the presence of argon gas.

As a result of analysis of the mixture thus obtained using an SEM, an XRD, an EPMA and the like, it was found that composite material particles of graphite particles having a particle size of approximately 10 μm and Si particles having a particle size of approximately 3 μm, i.e., agglomerated secondary particles of graphite particles and Si particles, were obtained. The weight proportion of the silicon (Si) to the whole composite material particles was approximately 30% by weight.

The same operations as in Example 1 were carried out except that the composite material particles thus obtained were used, to allow nickel nitrate to be carried and carbon nanofibers to grow, whereby a composite electrode active material E as illustrated in FIG. 4 was obtained. The fiber diameter and the fiber length of the grown nanofibers, the weight proportion of the carbon nanofibers to the whole composite electrode active material and the particle size of the catalyst particles were substantially the same as those in Example 1.

### EXAMPLE 6

24-hour grounding and mixing in the presence of argon gas using a planetary ball milling apparatus was carried out in the same manner as in Example 5 except that 100 parts by weight of silicon monoxide particles (manufactured by Wako Pure Chemical Industries, Ltd., reagent) obtained by grounding and classifying beforehand so as to have a mean particle size of 10 μm were used in place of 50 parts by weight of silicon particles.

As a result of analysis of the mixture thus obtained using an SEM, an XRD, an EPMA and the like, it was found that composite material particles of graphite particles having a particle size of approximately 10 μm and silicon monoxide particles having a particle size of approximately 3 μm, i.e., agglomerated secondary particles of graphite particles and silicon monoxide particles, were obtained. The weight proportion of the silicon monoxide to the whole composite material particles was approximately 50% by weight.

The same operations as in Example 1 were carried out except that the composite material particles thus obtained were used, to allow nickel nitrate to be carried and carbon nanofibers to grow, whereby a composite negative electrode active material F as illustrated in FIG. 4 was obtained. The fiber diameter and the fiber length of the grown nanofibers, the weight proportion of the carbon nanofibers to the whole composite electrode active material and the particle size of the catalyst particles were substantially the same as those in Example 1.

### EXAMPLE 7

The same operations as in Example 1 were carried out except that cobalt nitrate (II) hexahydrate (manufactured by Kanto Chemical Co., Inc., guaranteed reagent) was used in place of nickel nitrate (II) hexahydrate, whereby a composite negative electrode active material G as illustrated in FIG. 1 was obtained. The fiber diameter and the fiber length of the grown nanofibers, the weight proportion of the carbon nanofibers to the whole composite electrode active material and the particle size of the catalyst particles were substantially the same as those in Example 1.

### EXAMPLE 8

The same operations as in Example 1 were carried out except that 100 parts by weight of silicon monoxide particles obtained by grounding and classifying beforehand so as to have a mean particle size of 10 μm was exclusively used in place of 100 parts by weight of the mixture of silicon monoxide particles and artificial graphite, and the holding time in the mixture gas composed of 50% by volume of hydrogen gas and 50% by volume of methane gas in the step of growing carbon nanofibers was changed to 90 minutes, whereby composite particles were obtained. The fiber diameter and the fiber length of the grown nanofibers and the particle size of the catalyst particles were substantially the same as those in Example 1, and the weight proportion of the carbon nanofibers to the whole composite electrode active material was approximately 35% by weight. 100 parts by weight of the composite particles thus obtained and 65 parts by weight of artificial graphite were wet mixed in a mortar using N-methyl-2-pyrrolidone as a dispersion medium, whereby a composite electrode active material H as illustrated in FIG. 5 was obtained.

### EXAMPLE 9

The same operations as in Example 1 were carried out except that 100 parts by weight of artificial graphite was exclusively used in place of 100 parts by weight of the mixture of silicon monoxide particles and artificial graphite and the holding time in the mixture gas composed of 50% by volume of hydrogen gas and 50% by volume of methane gas in the step of growing carbon nanofibers was changed to 15 minutes, whereby composite particles were obtained. The fiber diameter and the fiber length of the grown nanofibers and the particle size of the catalyst particles were substantially the same as those in Example 1, and the weight proportion of the carbon nanofibers to the whole composite electrode active material was approximately 35% by weight. 100 parts by weight of the composite particles thus obtained and 100 parts by weight of silicon monoxide particles obtained by grounding and classifying beforehand so as to have a mean particle size of 10 μm were wet mixed in a mortar using N-methyl-2-pyrrolidone as a dispersion medium, whereby a composite negative electrode active material I as illustrated in FIG. 6 was obtained.

### EXAMPLE 10

The same operations as in Example 1 were carried out except that the holding time of the mixture carrying the catalyst in the mixture gas composed of 50% by volume of hydrogen gas and 50% by volume of methane gas was changed to 60 minutes in the step of growing carbon nanofibers, whereby a composite electrode active material J as illustrated in FIG. 1 was obtained. The fiber diameter and the fiber length of the grown nanofibers and the particle size of the catalyst particles were substantially the same as those in Example 1, and the weight proportion of the carbon nanofibers to the whole composite electrode active material was approximately 80% by weight.

### EXAMPLE 11

The same operations as in Example 3 were carried out except that the holding time of the composite particles carrying the catalyst in the mixture gas composed of 50% by volume of hydrogen gas and 50% by volume of methane gas was changed to 60 minutes in the step of growing carbon nanofibers, whereby a composite electrode active material K as illustrated in FIG. 1 was obtained. The fiber diameter and the fiber length of the grown nanofibers and the particle size of the catalyst particles were substantially the same as those in Example 1, and the weight proportion of the carbon nanofibers to the whole composite electrode active material was approximately 80% by weight.

### COMPARATIVE EXAMPLE 1

Herein, the material A comprising an element capable of forming an alloy with lithium was exclusively used, and the material B comprising carbon was not used. In other words, silicon particles (manufactured by Wako Pure Chemical Industries, Ltd., reagent) obtained by grounding and classifying beforehand so as to have a mean particle size of 15 μm was exclusively used in place of the dry mixture of silicon monoxide particles and artificial graphite, and the holding time for growing carbon nanofibers in the mixture gas composed of 50% by volume of hydrogen gas and 50% by volume of methane gas was changed to one hour, whereby a composite negative electrode active material L was obtained. The fiber diameter and the fiber length of the grown nanofibers, the weight proportion of the carbon nanofibers to the whole composite negative electrode active material and the particle size of the catalyst particles were substantially the same as those in Example 1.

### COMPARATIVE EXAMPLE 2

The same operations as in Comparative Example 1 were carried out except that the silicon monoxide particles (manufactured by Wako Pure Chemical Industries, Ltd., reagent) obtained by grounding and classifying beforehand so as to have a mean particle size of 15 μm was used in place of the silicon particles, whereby a composite negative electrode active material M was obtained. The fiber diameter and the fiber length of the grown nanofibers, the weight proportion of the carbon nanofibers to the whole composite negative electrode active material and the particle size of the catalyst particles were substantially the same as those in Example 1.

### COMPARATIVE EXAMPLE 3

100 parts by weight of the silicon monoxide particles (reagent manufactured by Wako Pure Chemical Industries, Ltd.) obtained by grounding and classifying beforehand so as to have a mean particle size of 10 μm and 100 parts by weight of artificial graphite (manufactured by TIMCAL Ltd., SLP30, mean particle size 16 μm) were dry mixed in a mortar for 10 minutes. 90 parts by weight of the resultant mixture and 10 parts by weight of acetylene black (manufactured by DENKI KAGAKU KOGYO K.K., DENKA BLACK) as a conductive agent were mixed, whereby a composite negative electrode active material N was obtained.

### COMPARATIVE EXAMPLE 4

In 100 parts by weight of deionized water, 1 part by weight of nickel nitrate (II) hexahydrate (manufactured by Kanto Chemical Co., Inc., guaranteed reagent) was dissolved. The solution thus obtained was mixed with 5 parts by weight of acetylene black (manufactured by DENKI KAGAKU KOGYO K.K., DENKA BLACK). The resultant mixture was stirred for one hour and then the water was removed with an evaporator to allow nickel nitrate (II) to be carried on the acetylene black. The acetylene black carrying nickel nitrate (II) was baked at 300° C. in the air to give nickel oxide particles having a particle size of approximately 0.1 μm.

Carbon nanofibers were grown under the same conditions as in Example 1 except that the nickel oxide particles thus obtained was placed in a ceramic reaction vessel and the holding time in the mixture gas composed of 50% by volume of hydrogen gas and 50% by volume of methane gas was changed to 60 minutes. As a result of analysis of the grown carbon nanofibers using an SEM, it was found that the carbon nanofibers had a fiber diameter of approximately 80 nm and a length of approximately 100 μm. The carbon nanofibers thus obtained were washed in an aqueous hydrochloric acid solution to remove the nickel particles, and thus carbon nanofibers containing no catalyst element were obtained.

100 parts by weight of the silicon monoxide particles (manufactured by Wako Pure Chemical Industries, Ltd., reagent) obtained by grounding and classifying beforehand so as to have a mean particle size of 10 μm and 100 parts by weight of artificial graphite (manufactured by TIMCAL Ltd., SLP30, mean particle size 16 μm) were dry mixed in a mortar for 10 minutes. To 80 parts by weight of the resultant mixture, 20 parts by weight of the carbon nanofibers obtained as described above as a conductive agent was added, whereby a composite electrode active material O was obtained.

### COMPARATIVE EXAMPLE 5

100 parts by weight of the silicon monoxide particles (manufactured by Wako Pure Chemical Industries, Ltd., reagent) obtained by grounding and classifying beforehand so as to have a mean particle size of 10 μm and 100 parts by weight of artificial graphite (manufactured by TIMCAL Ltd., SLP30, mean particle size 16 μm) were dry mixed in a mortar for 10 minutes. The resultant mixture was placed in a ceramic reaction vessel, and the temperature was raised to 1000° C. in the presence of helium gas. Thereafter, the helium gas was replaced with a mixed gas composed of 50% by volume of benzene gas and 50% by volume of helium gas, and the temperature was held at 1000° C. for one hour to carry out chemical vapor deposition (CVD). The mixed gas was then replaced with helium gas and the interior of the reaction vessel was cooled down to room temperature, whereby a composite electrode active material P was obtained. As a result of analysis of the composite electrode active material P using an SEM, it was found that the silicon monoxide particles and the graphite particles were covered with a carbon layer.

### COMPARATIVE EXAMPLE 6

The carbon nanofibers containing no catalyst element as obtained in Comparative Example 4 were exclusively used as an electrode active material Q.

[Evaluation]

(Fabrication of Coin Type Test Cells)

In order to evaluate characteristics of non-aqueous electrolyte secondary batteries containing the composite electrode active materials of Examples 1 to 9 and Comparative Examples 1 to 5, coin type test cells were fabricated by the following procedures.

100 parts by weight of the composite negative electrode active material, a dispersion of polyvinylidene fluoride (PVDF) (manufactured by Kureha Chemical Industry Co., Ltd., KF polymer) containing 7 parts by weight of polyvinylidene fluoride as a binder, and an appropriate amount of N-methyl-2-pyrrolidone (NMP) were mixed to prepare a negative electrode material slurry.

The slurry thus obtained was applied to a current collector made of a Cu foil having a thickness of 15 μm with a doctor blade and then dried in a dryer at 60° C. to cause the current collector to carry a negative electrode material mixture. The current collector carrying the negative electrode material mixture was punched into a disk of 13 mm in diameter to give a working electrode (negative electrode) for test cells.

A metallic lithium foil (manufactured by Honjyo Chemical Co., thickness 300 μm) was punched into a disk of 17 mm in diameter to give a counter electrode opposing the working electrode. Porous polypropylene sheet (manufactured by Celgard K.K., 2400, thickness 25 μm) was punched into a disk of 18.5 mm in diameter and interposed between the working electrode and the counter electrode as a separator, and then these were inserted in a coin type case of 2016 size. Non-aqueous electrolyte (manufactured by Mitsubishi Chemical Co., Sol-Rite) obtained by dissolving LiPF₆ at a concentration of 1 mol/L in a mixture solvent of ethylene carbonate (EC) and diethyl carbonate (DEC) was dropped in the case as an electrolyte. Finally, the opening of the case was closed with a sealing plate and caulked to finish a test cell.

(Initial Discharge Capacity and Irreversible Capacity)

With respect to the fabricated coin type test cells, an initial charge capacity and an initial discharge capacity were measured at a charge/discharge rate of 0.05 C. The measured initial discharge capacities are shown in Table 1.

Further, an irreversible capacity was determined from the difference between the initial charge capacity and the initial discharge capacity and then the proportion of the irreversible capacity to the initial charge capacity was calculated as a percentage. The results are shown in Table 1.

(Cycle Characteristics)

Relative to the initial discharge capacity obtained at a charge/discharge rate of 0.1 C, the proportion of the discharge capacity after the charge/discharge operation was repeated for 50 cycles at the same charge/discharge rate was calculated as a percentage to give a cycle characteristics. The results are shown in Table 1. Herein, the charge/discharge capacity was calculated as a capacity per unit weight (1 g) of the negative electrode material mixture excluding the weight of the binder.

(Fabrication of Coin Type Test Capacitors)

In order to evaluate characteristics of non-aqueous electrolyte electrochemical capacitors containing the composite electrode active materials of Examples 10 and 11 and Comparative Example 6, coin type test capacitors were fabricated by the following procedures.

80 parts by weight of powdered activated carbon (specific surface area 2000 m²/g, mean particle size 10 μm, product of activation by steam), 10 parts by weight of acetylene black, 10 parts by weight of polytetrafluoroethylene (PTFE) and an appropriate amount of deionized water were mixed to prepare a positive electrode material mixture slurry. The PTFE was used in a state of aqueous dispersion.

The slurry thus obtained was applied to a current collector made of an Al foil having a thickness of 15 μm with a doctor blade and then dried in a dryer at 120° C. to cause the current collector to carry positive electrode material mixture. The current collector carrying the positive electrode material mixture was punched into a disk of 13 mm in diameter to give a positive electrode for test cells.

The same operations as in fabricating the above-described coin type test cells were carried out except that the positive electrode thus obtained was used in place of the metallic lithium foil, whereby a coin type test capacitor was fabricated.

(Discharge Capacity)

With respect to the fabricated coin type test capacitors, charge/discharge from 2.5 V to 0 V was carried out at a current density of 1 mA/cm², to determine an electrostatic capacitance from the value of accumulated electric energy during discharge. The results are shown in Table 2. Herein, the electrostatic capacitance was determined as a capacity per unit weight (1 g) of the negative electrode material mixture excluding the weight of the binder.

TABLE 1

| | | Co- | | | Initial | | |
|---|---|---|---|---|---|---|---|
| | | presence of | CNF | | discharge | Irreversible | Cycle |
| | | carbon | growth | | capacity | capacity | characteristics |
| | CNF | material B | time | | (mAh/g) | (%) | (%) |
| Ex. 1 | With | Yes | 10 | min. | 720 | 17 | 91 |
| Ex. 2 | | | | | 1050 | 22 | 87 |
| Ex. 3 | | | | | 410 | 15 | 92 |
| Ex. 4 | | | | | 370 | 10 | 94 |
| Ex. 5 | | | | | 1180 | 10 | 85 |
| Ex. 6 | | | | | 740 | 16 | 92 |
| Ex. 7 | | | | | 720 | 17 | 91 |
| Ex. 8 | | Yes * | 90 | min. | 710 | 18 | 90 |
| Ex. 9 | | Yes | 15 | min. | 700 | 18 | 88 |
| Com. | With | No | 1 | hr. | 3180 | 15 | 76 |
| Ex. 1 | | | | | | | |
| Com. | | | | | 1160 | 25 | 82 |
| Ex. 2 | | | | | | | |
| Com. | Without | Yes | — | | 620 | 30 | 5 |
| Ex. 3 | | | | | | | |
| Com. | With ** | Yes * | 1 | hr. | 690 | 22 | 18 |
| Ex. 4 | | | | | | | |

| | | | | | | |
|---|---|---|---|---|---|---|
| Com. | Without | Yes | — | 670 | 24 | 16 |
| Ex. 5 | | | | | | |

CNF: carbon nanofiber
* Admixed after the growth of CNF on the material A
** CNF independent of the active material

TABLE 2

| | | | Electrostatic |
|---|---|---|---|
| | | Material A | capacitance |
| | CNF | Material B | (F/g) |
| Ex. 10 | With | With | 36.1 |
| Ex. 11 | | | 35.6 |
| Com. Ex. 6 | Without *** | Without | 31.8 |

*** CNF used singly

In Examples 1 to 9 there was obtained a higher discharge capacity than that obtained in the case where graphite was used singly, indicating that active materials having a charge/discharge capacity higher than the theoretical capacity of graphite can be obtained by using materials containing Si or Sn.

Examples 1 to 9 exhibited favorable cycle characteristics after 50 cycles of not less than 85%. This is ascribable to the fact that the carbon nanofibers grown on the surface of the active material particles prevented reduction in conductivity between the active material particles, the reduction being caused by volume change of the material A comprising an element capable of forming an alloy with lithium associated with charge/discharge.

In Comparative Examples 1 and 2, in which silicon or silicon monoxide was used singly, a high discharge capacity and favorable cycle characteristics were obtained; however, it took an extremely long time to grow carbon nanofibers compared with the case where a mixture or a composite material of silicon or silicon monoxide with graphite was used. Moreover, since the proportion of the content of a material whose volume change associated with charge/discharge is great is high in the negative electrode, the cycle characteristics were reduced compared with the case where graphite was used.

In Comparative Examples 3 to 5, in which carbon nanofibers were not grown on the surface of the active material particles, not only the initial discharge capacity was decreased but also almost no charge/discharge was carried out after 50 cycles. This indicates that simply mixing a conductive agent with the negative electrode mixture material or forming a carbon layer on the surface of the active material particles is not sufficient to obtain satisfactory effects of preventing reduction in conductivity between the active material particles.

Further, in Examples 10 and 11, a higher electrostatic capacitance was obtained than in Comparative Example 6, in which the carbon nanofibers were used singly, indicating that the capacity has increased by an amount corresponding to the amount of pseudocapacitance due to inclusion of a material capable of forming an alloy with lithium or a material comprising carbon.

From the results as described above, it was proved that by growing carbon nanofibers on the mixture or the composite material of the material A comprising an element capable of forming an alloy with lithium and the material B comprising carbon, it is possible to obtain non-aqueous electrolyte secondary batteries having a high charge/discharge capacity and excellent cycle characteristics, to increase the growth rate of the carbon nanofibers and thus to improve production efficiency, and further to obtain non-aqueous electrochemical capacitors having a high energy density.

### INDUSTRIAL APPLICABILITY

The composite electrode active material of the present invention is useful for a negative electrode active material for use in non-aqueous electrolyte secondary batteries that are expected to have a high capacity and non-aqueous electrolyte electrochemical capacitors that are expected to have a high energy density. In particular, the composite electrode active material of the present invention is suitably applicable for a negative electrode active material for use in non-aqueous electrolyte secondary batteries and non-aqueous electrolyte electrochemical capacitors that are high in electronic conductivity, excellent in initial charge/discharge characteristics and cycle characteristics and expected to be highly reliable.

1. A composite electrode active material for use in a non-aqueous electrolyte secondary battery or a non-aqueous electrolyte electrochemical capacitor comprising: a material A comprising an element capable of forming an alloy with lithium; a material B comprising carbon excluding carbon nanofiber; a catalyst element for promoting the growth of carbon nanofiber; and carbon nanofibers grown on at least one selected from a surface of said material A and a surface of said material B.

2. The composite electrode active material in accordance with claim 1, wherein said catalyst element is carried on at least one selected from the group consisting of said material A, said material B and said carbon nanofibers.

3. The composite electrode active material in accordance with claim 1, wherein said catalyst element is carried on at least one end of said carbon nanofibers.

4. The composite electrode active material in accordance with claim 1, wherein said element capable of forming an alloy with lithium is Si and/or Sn.

5. The composite electrode active material in accordance with claim 1, wherein said catalyst element is at least one selected from the group consisting of Mn, Fe, Co, Ni, Cu and Mo.

6. A method for producing a composite electrode active material for use in a non-aqueous electrolyte secondary battery or a non-aqueous electrolyte electrochemical capacitor, the method comprising the steps of:
obtaining a composite material or a mixture comprising a material A comprising an element capable of forming an alloy with lithium and a material B comprising carbon excluding carbon nanofiber;
allowing a compound comprising a catalyst element for promoting the growth of carbon nanofiber to be carried on at least one selected from a surface of said material A and a surface of said material B;
growing carbon nanofibers on at least one selected from the surface of said material A and the surface of said material B, while reducing said compound in a mixed gas of a carbon-containing gas and hydrogen gas;
baking said composite material or said mixture comprising said material A and said material B with said carbon nanofibers grown thereon, at 400° C. or higher and 1600° C. or lower in an inert gas atmosphere.

7. A non-aqueous electrolyte secondary battery comprising a negative electrode comprising the composite electrode active material in accordance with claim 1, a positive electrode capable of charge and discharge, a separator interposed between said negative electrode and said positive electrode, and a non-aqueous electrolyte.

8. A non-aqueous electrolyte electrochemical capacitor comprising a negative electrode comprising the composite electrode active material in accordance with claim 1, a positive electrode comprising a polarizable electrode material, a separator interposed between said negative electrode and said positive electrode, and a non-aqueous electrolyte.
